(19) United States
(12) Patent Application Publication
(10) Pub. No.: US 2026/0278423 A1
(43) Pub. Date: Sep. 17, 2026

(54) AUTONOMOUS ARTIFICIAL INTELLIGENCE (AI) AGENT CONTROL OF MULTITIER AI INFERENCE DISAGGREGATION

(71) Applicant: Dorian Cartwright, San Jose, CA (US)

(72) Inventor: Dorian Cartwright, San Jose, CA (US)

(21) Appl. No.: 19/630,125

(22) Filed: Mar. 26, 2026

Related U.S. Application Data
(60) Provisional application No. 63/970,881, filed on Jan. 29, 2026.
(60) Provisional application No. 63/978,933, filed on Feb. 9, 2026.

(51) Int. Cl. G06N 5/043

(52) U.S. Cl. CPC G06N 5/043

(57) ABSTRACT

A distributed artificial-intelligence inference system includes a master autonomous AI agent configured to control disaggregation of inference across multiple execution tiers. An input is received at an edge tier, and the master autonomous AI agent generates a plurality of candidate plans or branch continuations and instantiates corresponding sub-agents. The system identifies a shared inherited state common to multiple branches and branch-specific state corresponding to suffix portions after divergence. A promotion policy selects a promoted subset of branches for continuation at a data-center tier while maintaining a non-promoted subset at the edge tier. The promotion policy may evaluate branch score, local resource cost, transfer efficiency of shared-prefix state, model compatibility between source-tier and destination-tier models, branch type, network condition, and quality-related factors. A promotion package is generated including a shared-prefix reusable inference-state portion and separate branch-specific suffix portions for respective promoted branches. The data-center tier continues execution of the promoted subset using the promotion package. In some embodiments, the data-center tier further disaggregates inference among compute-dense, memory-centric, and persistence-oriented clusters. In some embodiments, an inference processor reconfigures an on-chip memory array between scratchpad mode and cache mode according to neural-network layer type.

### CROSS-REFERENCE TO RELATED APPLICATION

The present application claims priority under 35 U.S.C. § 119(e) to: (i) U.S. Provisional Patent Application No. 63/970,881, filed Jan. 29, 2026, by Dorian Cartwright, and entitled DISAGGREGATED ARTIFICIAL INTELLIGENCE INFERENCE USING HANDOFFS BETWEEN HETEROGENEOUS COMPUTE AND MEMORY ARCHITECTURES; and (ii) U.S. Provisional Patent Application No. 63/978,933, filed Feb. 9, 2026, by Dorian Cartwright, and entitled DYNAMICALLY RECONFIGURABLE MEMORY HIERARCHY FOR HYBRID NEURAL NETWORK ACCELERATION SEMICONDUCTORS, the entire disclosures of which are hereby incorporated by reference herein in their entireties.

### FIELD OF THE INVENTION

The present invention relates generally to artificial intelligence (AI) systems and distributed inference architectures, and more particularly, to a master autonomous AI agent controlling disaggregation of inference across multiple execution tiers.

### BACKGROUND

AI workloads are increasingly deployed across heterogeneous environments including user devices, robots, vehicles, gateways, appliances, enterprise edge systems, and remote data-center infrastructure. Edge execution can offer low latency, privacy preservation, and local autonomy, but is often constrained by processor availability, memory capacity, KV-cache growth, battery state, power budget, thermal headroom, and network variability. Remote infrastructure can provide access to larger models, larger memory pools, better verification models, enterprise tools, and specialized accelerators, but conventional systems often treat local-versus-remote inference as an all-or-nothing offload decision.

This binary treatment is especially deficient in agentic AI systems. A single user request, robotic objective, or application workflow may produce multiple candidate plans, multiple role-specific sub-agents, multiple branch continuations, or multiple verification paths. For example, one branch may attempt a direct answer, one may retrieve context, one may invoke a tool, one may evaluate safety, one may request clarification, and one may perform deeper reasoning. Conventional systems do not adequately address how a supervisory agent should preserve multiple live branches and selectively distribute those branches across edge and remote tiers based on technical execution criteria.

The problem becomes more acute where live branches share a common inherited state. Before divergence, multiple branches may share common prompt context, common conversation history, common retrieval results, common plan skeleton, or common reusable inference state such as transformer key-value cache. After divergence, each branch may accumulate branch-specific suffix state. Conventional offload approaches do not adequately handle transfer of only selected live branches while preserving branch-consistent association between shared-prefix state and branch-specific state. Naive duplication of complete cache state wastes bandwidth and memory, while simplistic shared transfer can corrupt branch identity or lose suffix association.

Conventional systems also do not sufficiently address compatibility across tiers. A first tier and a second tier may employ the same model instance, the same model architecture with different deployments, version-compatible models, quantization-compatible variants, distilled or paired models, or different models configured for branch-state reconstruction or continuation. Existing approaches do not adequately integrate model-compatibility analysis into a promotion decision governed by branch utility, resource cost, and shared-prefix transfer efficiency.

In addition, inference disaggregation may occur not only between edge and cloud, but also among multiple hardware clusters in a data center. Compute-dense accelerators may be well suited for prefill, memory-centric processors may be better suited for decode, and persistence-oriented processors may be better suited for persistent low-latency sessions. Existing systems do not adequately disclose a master autonomous agent that plans and modifies such multilevel disaggregation in real time in response to inferencing feedback, branch evolution, and resource conditions. DOR-025 also contemplates an optional further level of disaggregation within a chip by switching a shared on-chip memory array between a scratchpad mode for deterministic convolutional workloads and a cache mode for attention-based workloads.

### SUMMARY

These shortcomings are addressed by the present disclosure of methods, computer program products, and systems for a master autonomous AI agent control of multitier inference disaggregation.

In one embodiment, a master autonomous AI agent receives an input at an edge tier and generates a plurality of candidate plans, subtasks, or execution branches. The master agent instantiates or invokes a plurality of sub-agents associated with the candidate plans. The master agent preserves common inherited state for the plurality of branches and monitors branch-specific state as such branches diverge. The master agent then determines, for respective branches or sub-agents, whether execution is to remain at the edge tier, be promoted to a data-center tier, be assigned to a particular accelerator cluster, or be further reorganized within a processor memory subsystem.

In some embodiments, branch promotion is governed by a branch-promotion policy that evaluates one or more of: branch score, expected branch value, resource cost of local continuation, network condition, transfer efficiency of shared-prefix state, branch type, compliance or privacy need, and compatibility between a first-tier model and a second-tier model. The system forms a branch-consistent promotion package that preserves a shared-prefix reusable state portion and separately preserves one or more branch-specific suffix portions. The receiving tier may reconstruct, reference, replay, validate, or continue the promoted branch or branch set without full recomputation of the shared prefix.

In some embodiments, the master agent also governs cross-cluster inference disaggregation within a remote infrastructure. The master agent may further modify such routing in response to runtime inferencing feedback from remote clusters. In some embodiments, the master agent further performs within-chip disaggregation by dynamically reconfiguring a memory array between a scratchpad mode and a cache mode according to layer type.

Advantageously, computing devices and processes are improved with more versatile processing options for AI agents.

### BRIEF DESCRIPTION OF THE DRAWINGS

The present disclosure will be understood more fully from the detailed description given below and from the accompanying drawings of various embodiments of the disclosure.

FIG. 1 is a high-level block diagram illustrating a multitier agentic inference system, according to an embodiment.

FIGS. 2A-2D are a more detailed block diagrams illustrating master autonomous AI agent generating multiple candidate plans and instantiating corresponding sub-agents, according to an embodiment.

FIG. 3 is a more detailed block diagram illustrating an autonomous master AI agent of FIG. 1, according to an embodiment.

FIG. 4 is a high-level flow diagram illustrating a method of multitier agentic inferencing implementable in the system of FIG. 1, according to an embodiment.

FIG. 5 is a more detailed flow diagram illustrating a method for distributing sub-agent branches for disaggregated inferencing of input, according to an embodiment.

FIG. 6 is a more detailed flow diagram illustrating a method for promotion of sub-agent branch during live inferencing for dynamic disaggregation of input, according to an embodiment.

FIG. 7 is a more detailed flow diagram illustrating a method for inter-heterogeneous AI chip disaggregation according to sub-agent branch, according to an embodiment.

FIG. 8 is a more detailed flow diagram illustrating a method for intra-AI chip memory reconfiguration according to sub-agent branch, according to an embodiment.

FIG. 9 illustrates an example computing system configured to implement one or more of the embodiments disclosed herein.

### DETAILED DESCRIPTION

The description below provides methods, computer program products, and systems for a multitier agentic inference environment.

### I. Systems for Master-Agent Control of Multitier Disaggregation

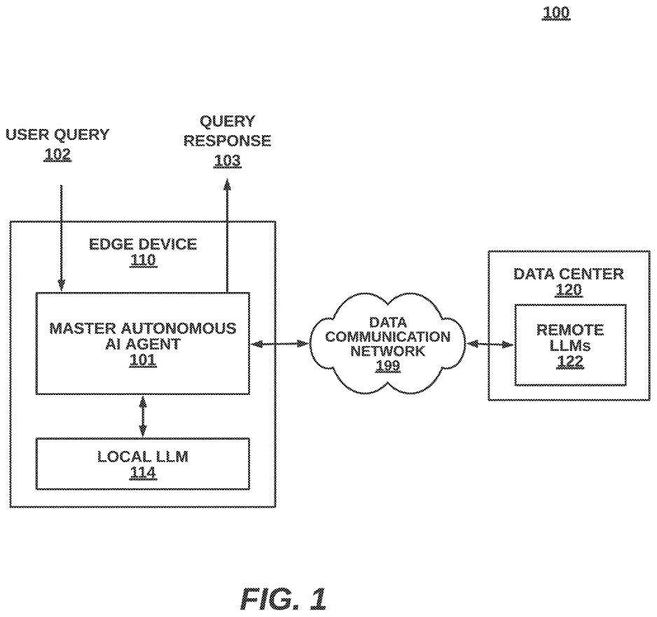

FIG. 1 is a block diagram illustrating an multitier agentic inference environment, according to an embodiment. In some embodiments, a distributed AI system 100 includes an edge device 110 as an edge tier, a data center 120 as a data center tier, and a master autonomous AI agent 101 with a control framework supervising execution of a plurality of sub-agents. The edge tier may include a mobile device, personal computer, robot, vehicle computer, local server, appliance, embedded device, headset, gateway, or other local compute platform. The data center tier may include one or more remote servers, cloud platforms, accelerator clusters, inference servers, or enterprise compute resources.

The master agent 101 may initially execute at the edge tier and may receive a user query 101, machine instruction, sensor-derived input, workflow request, robotic objective, or multimodal context, and return a query response 103. In some cases, a chatbot or other I/O interface uses a Natural Language Processor (NLP) for communicating with a user with voice or text. In other cases, the chatbot communicates with a process programmatically or with structured I/O. The master agent 101 may generate multiple candidate plans, subtask paths, or execution branches rather than committing immediately to a single continuation. For example, the master agent 101 may preserve a direct-answer branch, a retrieval branch, a tool-use branch, a planning branch, a safety-review branch, a clarification branch, a verification branch, a long-form generation branch, or a branch invoking a larger model.

In some embodiments, the master agent 101 can view inferencing feedback from lower-tier or remote-tier execution and can modify the disaggregation scheme in real time. For example, feedback can indicate cache growth, branch confidence, remote model availability, network delay, or cluster load may cause the master agent to promote, defer, terminate, merge, split, or re-rank one or more branches.

### A. Master Agent and Sub-Agent Hierarchy

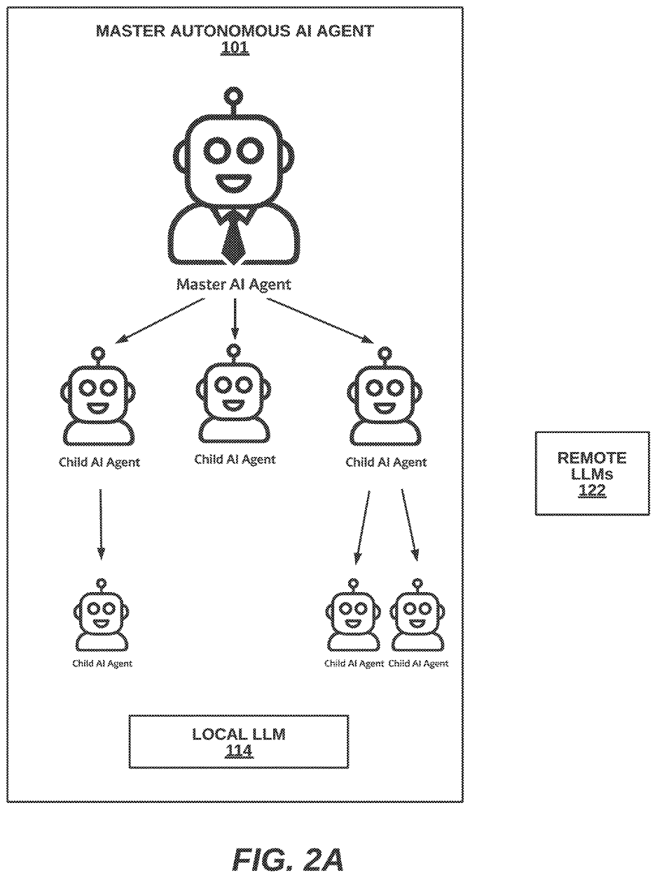

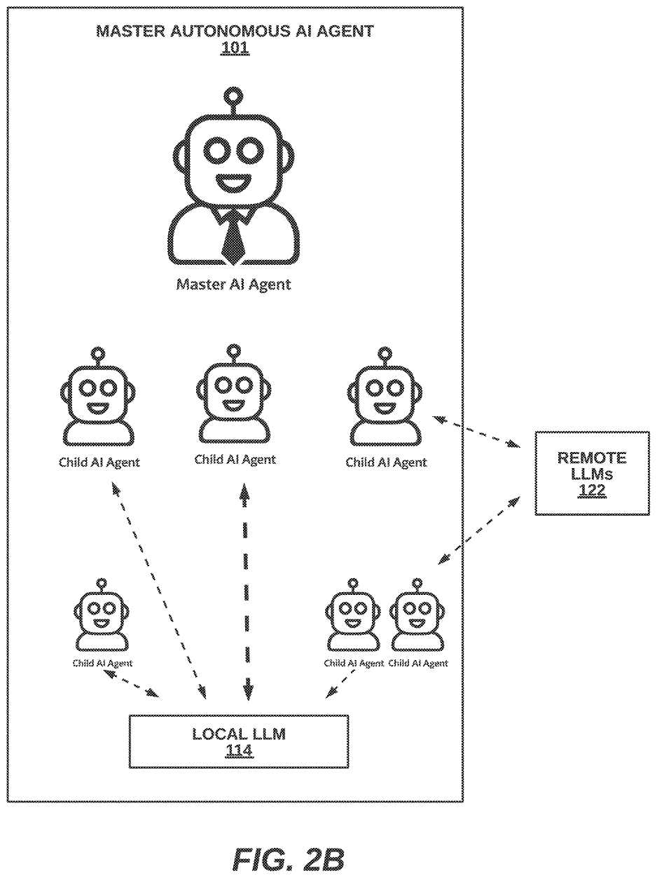

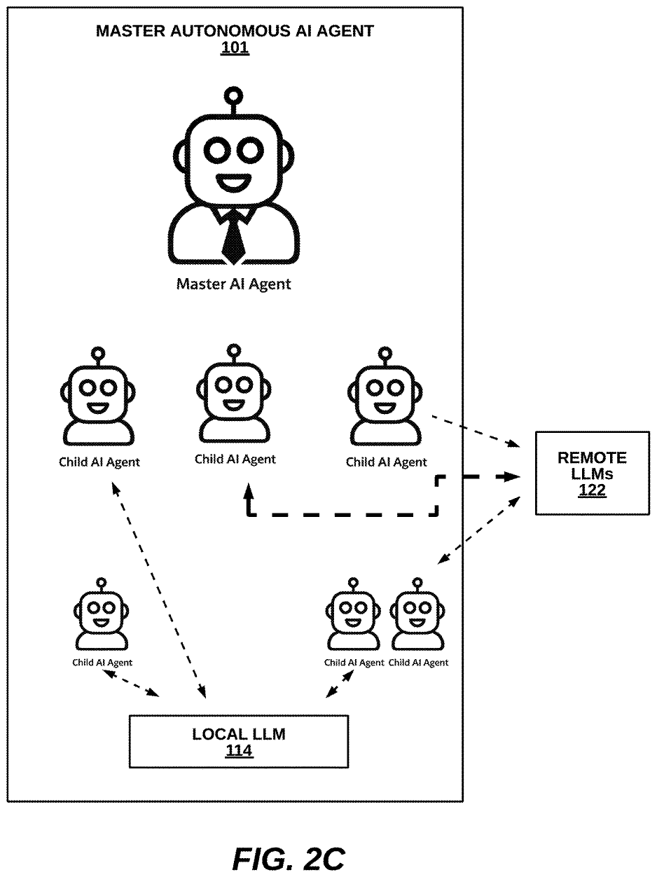

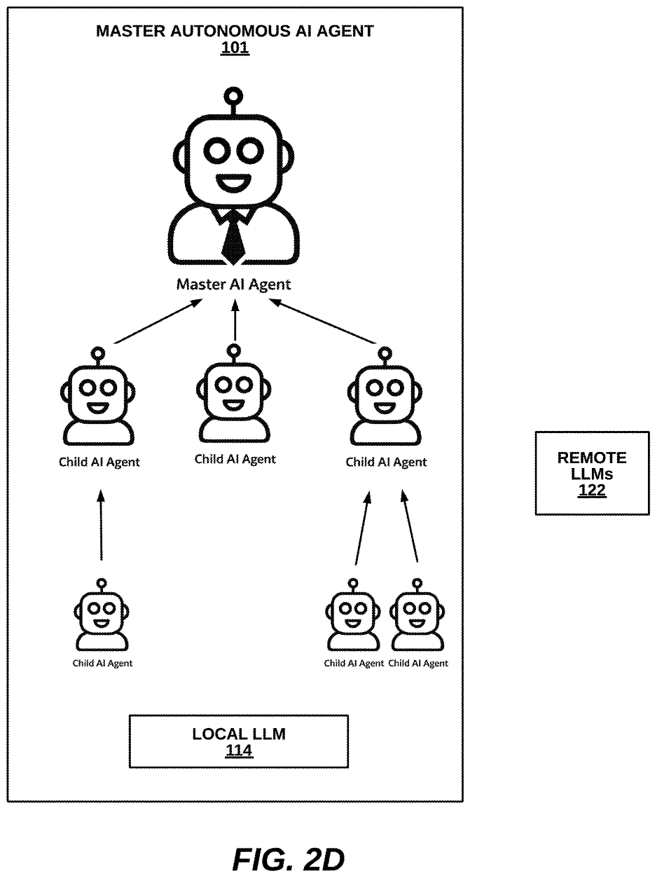

The master agent 101, in an embodiment, is configured to decompose a task into subtasks, preserve multiple candidate plans, instantiate sub-agents, allocate subtasks to those sub-agents or child agents (see FIG. 2A), receive outputs from those sub-agents (see FIG. 2D), and arbitrate among branch results. The master agent may maintain a global planning context, conversation state, task graph, policy context, memory store, branch lineage, and reusable inference-state map.

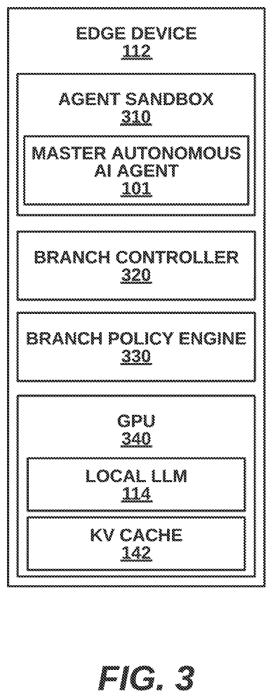

In FIG. 3, the edge device 110 includes an agent sandbox 310 with the autonomous master AI agent 101 and sub-agents, a branch controller 320, a branch policy engine 330, and a GPU 340 executing the local LLM 114. The agent sandbox 310 provides a barrier between agents and other edge device applications and operating system. An AI agent policy can control what external functionalities and components are assessable to agents and under what conditions. The branch controller 320 can receive configurations and runtime data concerning inference branches and associated resources necessary for the master agent 110 to make branching decisions. The branch policy engine 330 can store deterministic rules its own small language model as guidance for branching decisions. The GPU 340 stores weights and parameters for executing local LLM 114 when called. A KV cache 142 stores keys and values during inferencing that may be shared to the data center tier, or in some embodiments, to a different AI chip, as discussed below. The GPU 340, some cases, also include reconfigurable memory for switching between a scratchpad mode and a cache mode, also discussed more fully below. Other implementation and components not included in FIG. 2 are possible, such as CPU, an operating system, applications, network interface hardware, user interfaces, displays, and the like.

Sub-agents may include, by way of example, direct-response sub-agents, retrieval sub-agents, tool-use sub-agents, reasoning sub-agents, verification sub-agents, clarification sub-agents, safety or compliance sub-agents, actuation-planning sub-agents, ranking sub-agents, summarization sub-agents, and transformation sub-agents. A sub-agent may be implemented as a model instance, prompt-defined role, process, containerized module, orchestrated tool wrapper, or policy-governed inference module. One or more sub-agents may themselves instantiate subordinate agents, thereby creating a hierarchical supervisory structure. In some cases, sub-agents themselves spawn one or more subservient sub-agents. Those subservient sub-agents can be subject to the master agent 101 directly or via confines of its own master, sub-agent.

In some embodiments, branching occurs when the master agent 101 preserves more than one continuation from a common prior state. Branching may arise from decoding alternatives, planning alternatives, safety alternatives, tool alternatives, ambiguity or uncertainty alternatives, multimodal interpretation alternatives, model-size escalation alternatives, or competing optimization goals. In one example, a user input requesting a memorandum is split into branches by the master agent 101 between a sub-agent tasked with a financial analysis, a sub-agent tasked with logistical analysis, a sub-agent tasked with engineering analysis, and a sub-agent tasked with marketing analysis, either directly or on indirectly through additional sub-levels.

A plurality of branches may share common inherited state corresponding to a common prompt, common planning context, common conversation history, common retrieval result set, common environment model, common plan skeleton, or common reusable inference state. Branch-specific state may include branch-local tokens, prompts, tool outputs, reasoning traces, retrieved materials, subtask outputs, or suffix key-value state generated after divergence. The system may explicitly identify a branch boundary between shared-prefix state and branch-specific suffix state. Such a boundary may be represented by token index, sequence offset, cache page boundary, block identifier, tree node marker, or other segmentation marker.

In some embodiments, shared-prefix state is stored once and referenced by multiple branches, while suffix state is stored as branch-private objects, overlays, deltas, appended segments, or branch-local pages. This allows the master agent 101 to reason explicitly about duplication avoidance, transfer efficiency, and continuation correctness.

### B. Edge-to-Cloud Branch Promotion

Branch promotion can occur for one or more branches that begin execution at an edge tier and are later promoted to a data center tier (see FIGS. 2B and 2C). Promotions may apply for some branches, while other branches remain local. Promotion is therefore not merely session offload; rather, it is selective promotion of one or more live branches while preserving branch identity, lineage, and reusable inherited state continuity. Branches can also be demoted, in some implementations, such as when human-facing finalization is necessary, network has degraded or failed over, privacy or sensitivity issues arise during execution, or heavy computation has completed.

When a selected branch or selected set of sibling branches is promoted, the system forms a promotion package. The promotion package may include a session identifier, branch set identifier, one or more branch identifiers, shared-prefix reusable state or a reference thereto, one or more branch-specific suffix portions, branch boundary descriptors, lineage metadata, token ranges, cache integrity markers, cache version markers, continuation instructions, policy metadata, and model compatibility descriptors. The shared-prefix portion may be transferred once for multiple promoted branches, reducing redundant transfer of duplicate state.

At the receiving data center tier, the system may instantiate a branch-consistent representation including a shared-prefix state object and a plurality of suffix state objects respectively associated with promoted branches. The receiving tier may then continue inference without replaying the entire shared prefix, or may partially replay, validate, translate, or reconstruct state as needed for compatibility or fault tolerance. Copy-on-write techniques, immutable shared segments, overlay tensors, reference counts, or branch-private pages may be used to preserve safe continuation.

In some embodiments, branch promotion is conditioned not only on branch desirability but also on compatibility between the source-tier model and the destination-tier model. The first and second tiers may use: the same model instance; the same model architecture with different deployments; version-compatible models; quantization-compatible variants; distilled or paired models; or different models configured for branch-state reconstruction or continuation. In an implementation, several different models available on local LLM 114 correspond to respective compatibility to several different models on one more different data centers.

For example, a branch may begin on a small on-device model and continue on a larger remote model that accepts transferred reusable state directly. In another embodiment, the remote model may be a quantization-compatible variant configured to accept cache translation. In another embodiment, a paired model may reconstruct the source-state representation based on descriptors, checkpoints, hashes, token ranges, or replay material. In another embodiment, the system may reject promotion of an otherwise valuable branch where compatibility, version, tokenizer, precision, or positional-encoding alignment is inadequate.

A branch-promotion policy selects one or more branches based on one or more of three principal considerations: branch score, resource cost, and transfer efficiency of shared-prefix state, in one instance. In another instance, additional considerations may also be used with implementation-specific weightings.

### 1. Resource-Based Criteria

A branch may be promoted when local continuation becomes expensive or impractical. The resource-based criteria may include whether a branch is predicted to exceed a latency budget, token budget, memory budget, KV-cache budget, thermal budget, battery or power budget, or edge compute availability. A branch having a long predicted continuation, large suffix-KV growth, or high expected recomputation cost may be promoted, while a shorter branch may remain local.

### 2. Quality-Based Criteria

A branch may be promoted if stronger remote compute is likely to improve output quality. Such criteria may include low confidence, need for deeper reasoning, unresolved ambiguity, need for a larger model, need for better ranking, or need for stronger verification. Thus, a direct-answer branch may remain on-device while a difficult reasoning branch is promoted remotely.

### 3. Branch-Value or Utility Criteria

Each branch may be scored using one or more utility measures such as probability, beam score, semantic relevance, user-value score, task-completion likelihood, expected reward, or policy-weighted usefulness. In some embodiments, only the top-ranked subset of branches is promoted. For example, only two of eight live branches may be promoted.

### 4. Branch-Type Criteria

Certain branch classes may be predesignated for remote handling, such as tool-use branches, long-form generation branches, safety-review branches, planning branches, retrieval-heavy branches, or branches requiring enterprise policy enforcement. Conversely, user-visible clarification branches or ultra-low-latency response branches may be kept local by default.

### 5. User or Application Priority Criteria

Promotion may depend on application context. Interactive user-visible branches may receive priority; background branches may be deferred; premium-service branches may receive remote escalation; mission-critical robotic branches may receive higher-quality remote planning; and time-sensitive branches may be kept local if remote delay is unacceptable.

### 6. Network and Infrastructure Criteria

Promotion may depend on bandwidth, round-trip latency, connection stability, remote-cluster load, remote-model availability, expected promotion delay, or cost of remote compute. A high-value branch may nevertheless remain local where network conditions are poor or remote infrastructure is unavailable.

### 7. State-Structure Criteria

In some embodiments, branch selection depends on state structure itself. Relevant factors may include size of shared-prefix KV state, size of branch-specific suffix KV state, amount of overlap across candidate branches, recomputation cost if promotion is not performed, and efficiency gain from transferring a shared-prefix portion once for multiple sibling branches. This criterion closely aligns promotion with the branch-consistent KV-handling aspect of the invention. A sibling branch set sharing a large common prefix may therefore be promoted together because the shared-prefix state may be transferred once and reused remotely.

### 8. Event-Triggered Criteria

Promotion may be triggered by particular events, such as reaching a divergence-depth threshold, invoking a restricted tool, crossing a confidence threshold, being flagged for human-facing finalization, entering a safety-sensitive state, or exceeding a local interruption or restart threshold.

In some embodiments, branch placement and promotion are further governed by privacy, compliance, export-control, or enterprise data-handling rules. Inputs or inherited state may be classified as private, regulated, confidential, export-controlled, enterprise-internal, or safe for remote processing. A branch operating on raw sensitive material may remain local, while a transformed or redacted derivative branch may be promoted remotely. Governance markers, authority constraints, data-handling restrictions, and allowable tool scopes may accompany a promoted branch so that remote continuation remains subject to local-origin policy.

### C. Multitier Remote Inference Across Heterogeneous AI Chips

Heterogeneous AI chips, assessable by the master agent 101, can lead to further or alternative disaggregation scenarios. In some embodiments, once a branch or sub-agent is assigned to remote execution, the master agent 101 or a unified inference gateway further disaggregates inference among a computer-dense cluster, a memory-centric cluster and/or a low-latency, persistence cluster. In one case, commands are sent upstream as suggestions or directives, using public protocol or private proprietary formats. Alternatively, a master agent at the data center tier can manage the split using its own inference disaggregation policies specific to heterogeneous resources. Individual inferences or sub-inferences can be split amongst resources, and further, an individual inference can be partially processed on more than one heterogeneous resource.

The compute-dense cluster may perform the prefill phase, ingesting prompt or multimodal context and generating a reusable state such as a KV cache. This supercomputing architecture that aims to maximize the concentration of processing cores, often GPUs, within a limited physical space to deliver extreme peak floating-point performance. An excellent example is a cluster built with liquid-cooled NVIDIA Blackwell GB200 NVL72 systems, which integrates 72 Blackwell GPUs into a single rack, enabling massive scale-up AI inference with an ultra-high bandwidth interconnect.

The memory-centric cluster may receive the reusable state over a high-speed interconnect and perform decode, which is often more memory-bandwidth bound than compute bound. More specifically, a high-performance computing architecture centers the system around massive, pooled memory resources rather than individual processors, fundamentally shifting the focus from compute-to-data to data-to-compute. This design allows disaggregated compute nodes (CPUs, GPUs) to access a single, large, coherent shared memory pool over a high-speed fabric, enabling rapid parallel processing for data-intensive workloads and the independent scaling of memory and compute capabilities.

The persistence cluster, such as a large wafer-scale or ultra-low-latency memory-rich architecture, may host persistent-state agentic sessions in which handoff overhead should be avoided or minimized. For example, Cerebras Systems utilizes a wafer-scale architecture that distributes 44 GB of fast SRAM directly alongside 900,000 compute cores, enabling an intermediate computational state to persist locally with extreme bandwidth. This design allows immediate data state, like activations, to remain spatially persistent in SRAM, while massive model weights are disaggregated to external storage and streamed onto the wafer as needed.

Routing among such clusters may be based on predicted token count, predicted output length, temporal-cognitive requirement, latency sensitivity, persistence needs, or branch class. In some embodiments, a reverse cooperation mode is used in which a memory-centric cluster attempts a token prediction that is checked or completed by a compute-dense cluster. In other embodiments, a persistent-state branch bypasses handoff and is routed directly to a persistence-oriented cluster. The master agent may revise these assignments during execution based on inferencing feedback from the clusters.

### D. Within-Chip Disaggregation Using Reconfigurable Memory

Disaggregation within an AI chip provides still further levels of resource allocation available to the master agent 101. As discussed above, this can be in cooperation with or exclusive to the data center tier. These optimizations can also apply to local inferencing.

An AI chip or inference accelerator may include a configurable memory array, addressing logic, and a mode controller that identifies a layer type to be processed. For deterministic convolutional workloads, the mode controller may place, or be directed by the master agent 101 to place, the memory in a scratchpad mode in which memory access is based on direct physical addressing and hardware tag comparison is disabled. For attention-based or transformer workloads, the mode controller may place the same physical memory cells in a cache mode in which the cells are logically partitioned into sets and ways and accesses are governed by tag comparison and hardware-managed policies.

A transition mechanism may detect a change in layer type based on a layer hint or mode bit in an instruction stream. When switching from cache mode to scratchpad mode, a flush operation may write back dirty cache lines to external memory. When switching from scratchpad mode to cache mode, an invalidate operation may clear entries for subsequent caching. This creates a modal boundary preserving data coherence across the transition.

### II. Methods for Master-Agent Control of Multitier Disaggregation

### A. Master Agent-Controlled Multitier Disaggregation

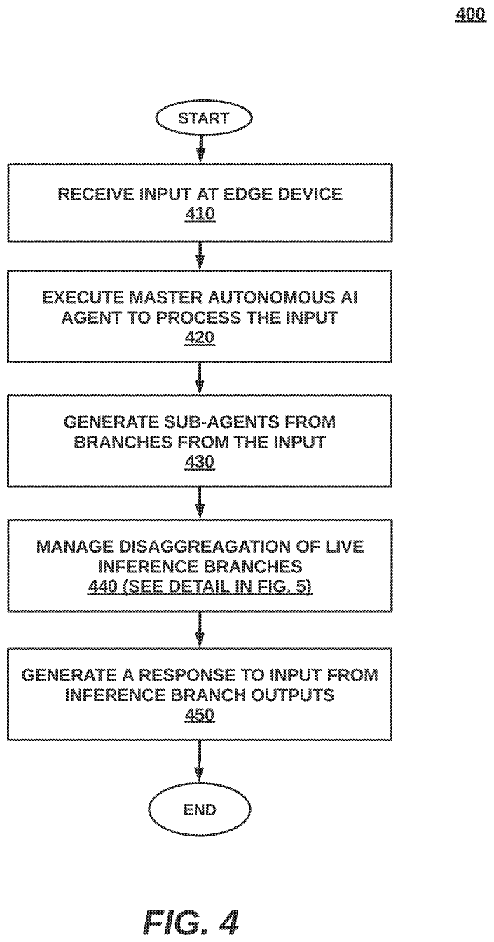

In FIG. 4, a method 400 may include receiving an input at an edge tier 410; executing a master autonomous AI agent at the edge tier 420; generating a plurality of candidate plans or branches 430; managing live inference branches 440; and generating 450 a resulting response, workflow action, or physical control action. Different responses can be synthesized into a single response, sometime using further inferencing, or kept separate.

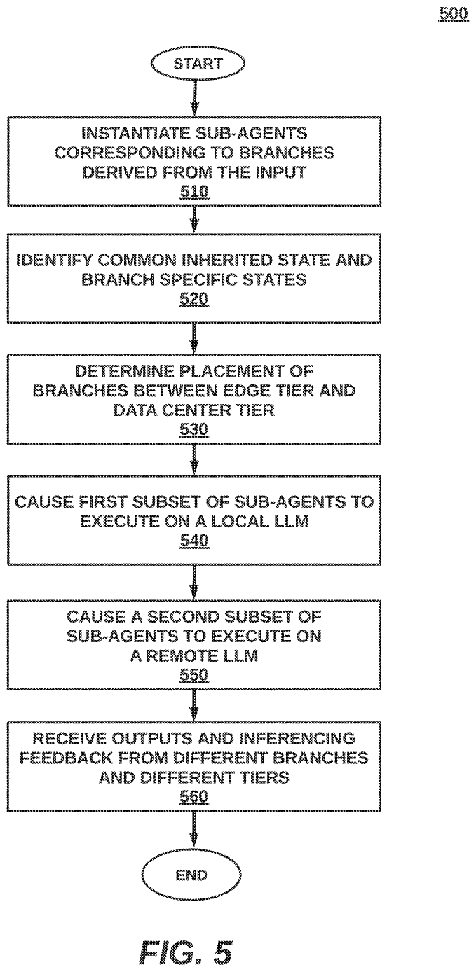

A method 500 of FIG. 5 illustrates one example of step 440 for managing live inference branches and includes: instantiating a plurality of sub-agents corresponding to the branches 510; identifying common inherited state and branch-specific state 520; determining placement of respective branches among an edge tier and one or more remote tiers 530; causing a first subset to continue locally 540; causing a second subset to be promoted remotely 550; receiving outputs and inferencing feedback from the different tiers 560.

### B. Branch-Consistent Promotion

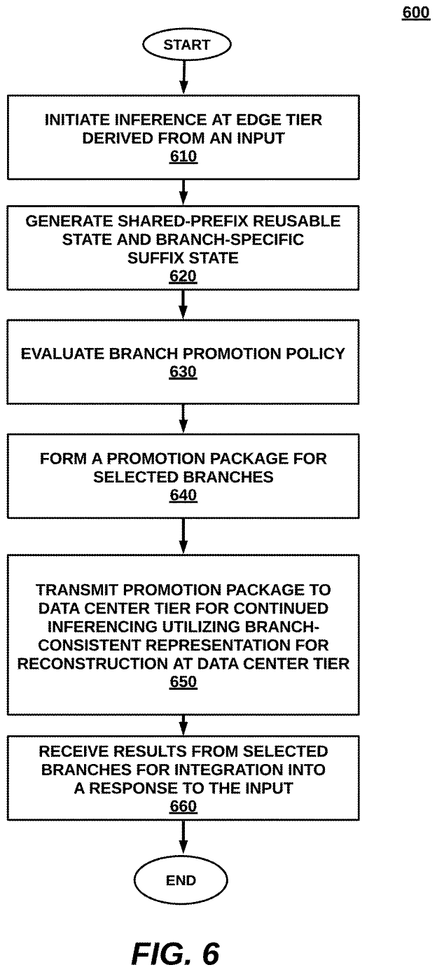

In FIG. 6, a method 600 may include initiating inference at an edge tier 610; generating shared-prefix reusable state and branch-specific suffix state 620; evaluating a promotion policy that incorporates at least branch score, resource cost, transfer efficiency of shared-prefix state, and model compatibility 630; selecting a subset of live branches 640; forming a promotion package including shared-prefix state and separate suffix state for each selected branch 650; transmitting the package to a data center tier 660; reconstructing a branch-consistent representation at the data center tier 670; and continuing inference for the promoted branches 680.

### C. Inter-AI Chip Heterogeneous Remote Routing

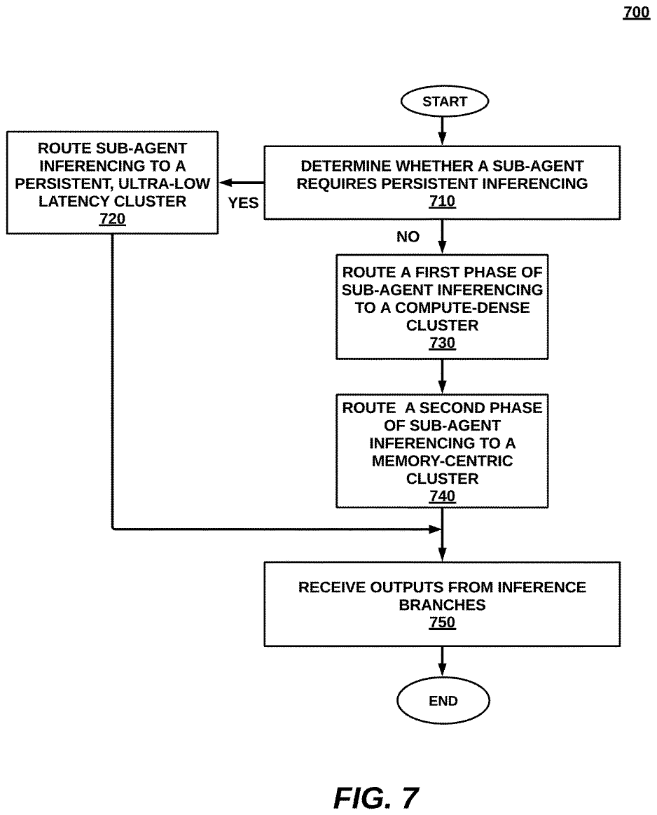

In FIG. 7, a method 700 may include determining whether a sub-agent requires a persistent inferencing 710; and if so, routing a persistent or ultra-low-latency session to a persistence cluster 720, wherein the routing is determined by the master agent or a unified inference gateway based on branch type, latency requirements, expected output length, temporal-cognitive requirement, or runtime feedback; and if not, routing a first phase of inference to a compute-dense cluster 730 followed by routing a second phase to a memory-centric cluster 740. Method 700 can be performed in conjunction with, or independent from, method 500 in master agent management of live inference branches, either at an edge tier LLM or data center LLMs.

### D. Intra-AI Chip Memory Reconfiguration

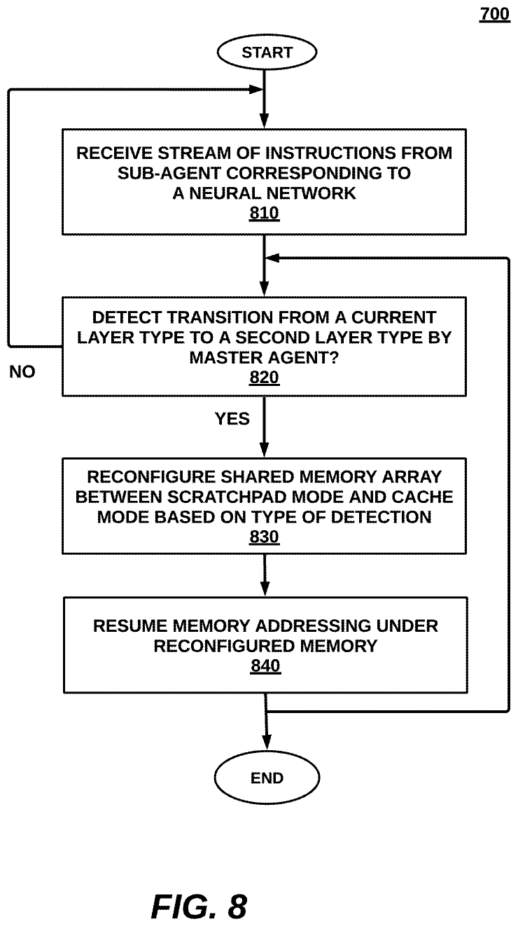

In FIG. 8, a method 800 may include receiving a stream of instructions from a sub-agent corresponding to a neural network 810; detecting a transition from a current layer type to a second layer type 820; draining pending memory requests, reconfiguring a shared memory array from a scratchpad addressing mode to a cache addressing mode or vice versa 830, performing flush or invalidate operations; and resuming execution under the second addressing mode 840, until session ends. In one embodiment, a master agent or sub-agent sends a signal or other indication indicating layer type ahead of instruction streams, while in another embodiment, detection is independently detected by on-chip or by other software (e.g., operating system). Method 800 can be performed in conjunction with, or independent from, method 500 in master agent management of live inference branches, either at an edge tier LLM or data center LLMs.

### III. Computing Environment for Master-Agent Control of Multitier Disaggregation

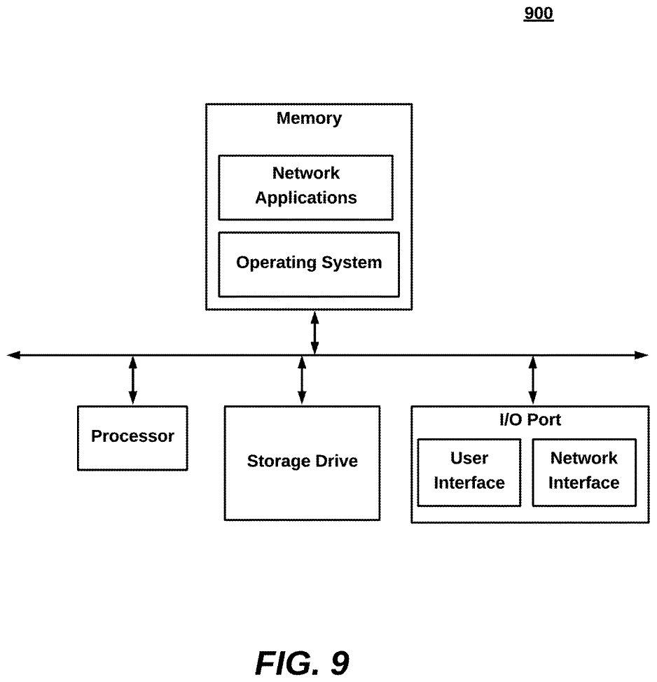

In FIG. 9, a computing environment 900 implementable by various components of system 100 including: a memory with network applications and an operating system, a processor, a storage drive, and an I/O port with a user interface and a network interface, all coupled via a bus. The processor executes instructions to perform the operations described herein. The processor may be implemented as a single central processing unit (CPU), a single graphics processing unit (GPU), a neural processing unit (NPU), or an array of interconnected processors. In high-performance or AI-optimized configurations, the processor may comprise a CPU cooperating with one or more GPUs, or a massive array of interconnected GPUs. For example, the local device may utilize dedicated hardware accelerators, such as NVIDIA GPUs (e.g., RTX series or Blackwell architecture) or Qualcomm processors, specifically optimized for running local Small Language Models SLMs and executing edge inferencing securely without exporting data.

Generic Software and Agent Ecosystems The operations of the firewall and privacy router are typically implemented as generic software—comprising computer-executable instructions stored on a non-transitory computer-readable medium (e.g., RAM, ROM, NVMe SSDs) that, when executed by the processor, cause the computing device to perform the described methods.

Within this software environment, the underlying Operating System (OS) manages hardware resources and provides common services. The OS may be a traditional system (e.g., Microsoft Windows, Apple iOS, Android, Linux) or an emerging agent-based OS designed natively around autonomous reasoning. The software environment may also include structural security sandboxes or isolated execution runtimes, such as the Windows Copilot runtime or NVIDIA NemoClaw (using the OpenShell architecture), which enforce baseline permissions. Operating within or alongside these operating systems and sandboxes are the AI agents. These may include background service agents, cross-application automation tools, or autonomous agent frameworks such as OpenClaw (or other “claw”-based architectures) and Anthropic's Claude Cowork.

Furthermore, the software ecosystem includes the inference engines themselves. These range from local SLMs to remote LLMs provided by third parties, such as ChatGPT (OpenAI), Claude (Anthropic), Gemini (Google), Perplexity, DeepSeek, or Meta Llama. These external LLMs dynamically process the outbound prompts routed by the privacy router. In doing so, these models heavily utilize KV caches to store attention states and session context during generation. The local computing devices and remote LLM servers communicate via a generic network infrastructure. This network may comprise a Local Area Network (LAN), a Wide Area Network (WAN), cellular networks (e.g., 5G), Wi-Fi, and the public Internet.

In the context of the present disclosure, this generic network serves as the conduit for LLM transactions. The network handles the transmission of prompts, tool outputs, and model responses between the local device and the external LLM providers.

This description of the invention has been presented for the purposes of illustration and description. It is not intended to be exhaustive or to limit the invention to the precise form described, and one of ordinary skill in the art will recognize many modifications and variations are possible in light of the teaching above. The embodiments were chosen and described in order to best explain the principles of the invention and its practical applications, in a concise manner. This description will enable others skilled in the art to best utilize and practice the invention in various embodiments and with various modifications as are suited to a particular use.

The scope of the invention is defined by the following claims.

I claim:

1. A computer-implemented method, comprising:
receiving, by a master autonomous artificial intelligence agent executing at an edge tier, an input corresponding to a user request or a workflow request, wherein the master autonomous artificial intelligence agent is configured to:
generate a plurality of concurrently live inference branches corresponding to the input and assign a plurality of sub-agents respectively to the plurality of concurrently live inference branches;
selecting, for respective ones of the plurality of sub-agents, whether execution is to remain at the edge tier or transferred to a data center tier based on runtime criteria;
cause a first subset of the plurality of sub-agents to continue execution at the edge tier while a second subset of the plurality of sub-agents is transferred to continue execution at the data-center tier;
receive inferencing feedback from at least one of the plurality of sub-agents executing at the edge tier and at least one of the plurality of sub-agents executing at the data-center tier; and
generate, by the master autonomous artificial-intelligence agent, an output to the user request or the workflow request based on coordinated results produced by at least portions of the first subset and the second subset.

2. The method of claim 1, wherein the determination of whether execution is to remain at the edge tier or continue at a data center tier is based at least partially on a characteristic of the input.

3. The method of claim 1, wherein the determination of whether execution is to remain at the edge tier or continue at a data center tier is based at least partially on a characteristic of a response received from at least one of the concurrently live inference branches.

4. The method of claim 1, wherein the determination of whether execution is to remain at the edge tier or continue at a data center tier is based at least partially on a privacy policy of the edge tier.

5. The method of claim 1, wherein the determination of whether execution is to remain at the edge tier or continue at a data center tier is based at least partially on a required response latency of a live inference branch being considered.

6. The method of claim 1, wherein the determination of whether execution is to remain at the edge tier or continue at a data center tier is based at least partially on a token length of a live inference branch being considered.

7. The method of claim 1, wherein the determination of whether execution is to remain at the edge tier or continue at a data center tier is based at least partially on hardware resources of the edge tier.

8. The method of claim 1, wherein an inferencing model of the edge tier is compatible with an inferencing model of the data center tier.

9. The method of claim 1, wherein receiving, by a master autonomous artificial intelligence agent executing at an edge tier, an input corresponding to a user request comprises receiving the user request from a chatbot interface with a user.

10. The method of claim 1, wherein receiving, by a master autonomous artificial intelligence agent executing at an edge tier, an input corresponding to a workflow request comprises receiving the workflow request from a different autonomous artificial intelligence agent.

11. The method of claim 1, wherein the master autonomous artificial agent executes at an edge tier using an inferencing model located at the edge tier.

12. The method of claim 1, wherein the edge tier comprises one or more of a personal computer, a smart phone, an IoT device, and an appliance.

13. The method of claim 1, wherein the inferencing feedback received from at least one of the plurality of sub-agents executing at the edge tier and at least one of the plurality of sub-agents executing at the data-center tier causes the master autonomous artificial intelligence agent to modify at least one of:
a tier assignment of a sub-agent,
a branch-selection decision,
a promotion decision for a live inference branch, or an arbitration decision among the plurality of concurrently live inference branches.

14. A computer-implemented method, comprising:
receiving, by a master autonomous artificial intelligence agent executing at an edge tier, an input corresponding to a user request or a workflow request, wherein the master autonomous artificial intelligence agent is configured to:
generate a plurality of concurrently live inference branches corresponding to the input and assign a plurality of sub-agents respectively to the plurality of concurrently live inference branches;
identify a shared-prefix reusable inference-state portion common to the plurality of concurrently live inference branches prior to branch divergence, and branch-specific suffix state portions corresponding to respective inference branches after branch divergence;
determine, for respective ones of the plurality of sub-agents during ongoing execution, whether execution is to remain at the edge tier or continue at a data-center tier based on at least the shared-prefix reusable inference-state portion;
cause a first subset of the plurality of sub-agents to continue execution at the edge tier while a second subset of the plurality of sub-agents is transferred to continue execution at the data-center tier; and
receive inferencing feedback from at least one of the plurality of sub-agents executing at the edge tier and at least one of the plurality of sub-agents executing at the data-center tier.

15. The method of claim 14, wherein the artificial intelligence agent causes a first subset of the plurality of sub-agents to continue execution at the edge tier while a second subset of the plurality of sub-agents is transferred to continue execution at the data-center tier, including forming and sending the shared-prefix reusable inference-state portion and the respective branch-specific suffix state portions associated with the second subset.

16. The method of claim 14, wherein sending the shared-prefix reusable inference-state portion and the respective branch-specific suffix state portions associated with the second subset comprises sending data from a transformer key-value cache corresponding to the second subset of sub-agents.

17. The method of claim 14, wherein the autonomous artificial intelligence agent causes a third subset of sub-agents to be transferred from a first device having a first type of AI processor to a second device having a second type of AI processor, depending on at least one live inference branch associated with the third set of sub-agents, including sending the shared-prefix reusable inference-state portion and the respective branch-specific suffix state portions associated with the third subset of sub-agents.

18. The method of claim 14, wherein the autonomous artificial intelligence agent causes a fourth subset of sub-agents to reconfigure a memory component an AI processor, between a scratchpad mode and a cache mode, depending on a live inference branch associated with the fourth subset of sub-agents.

19. A method, comprising:
receiving an inference request,
routing a prefill phase to a compute-dense processing cluster to generate reusable inference state,
transferring the reusable inference state over an interconnect to a memory-centric processing cluster to perform sequential decode,
selectively routing a persistent or ultra-low-latency session to a persistence cluster, and
controlling the routing based on phase type, session type, or runtime execution condition.

20. A semiconductor processor comprising:
a memory array configurable in a scratchpad mode and a cache mode;
a controller configured to detect a neural-network layer type;
logic configured to place the memory array in scratchpad mode for a deterministic convolutional workload and in cache mode for an attention-based workload; and
a transition mechanism configured to perform a coherency-preserving operation during transition between the modes.
